(19) United States
(12) Patent Application Publication
(10) Pub. No.: US 2008/0222478 A1
(43) Pub. Date: Sep. 11, 2008

(54) Retransmission method and wireless communication system

(75) Inventor: Tsuyoshi Tamaki, Machida (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/071,130

(22) Filed: Feb. 15, 2008

(30) Foreign Application Priority Data
Mar. 9, 2007 (JP) 2007-059381

(51) Int. Cl. H04L 1/08; G06F 11/14

(52) U.S. Cl. 714/749; 714/E11.113

(57) ABSTRACT

Disclosed herewith is a communication method employed for a wireless communication system. The method controls retransmission in case where wireless communication between a data transmitter and a data receiver in the system is unstable, thereby suppressing increasing of a communication delay time that might otherwise be caused by the retransmission control, thereby reducing transmission error occurrence. The transmitter node transmits a wireless signal including data while the receiver node receives the wireless signal and checks the received signal for error existence. If not detecting any error in the received data, the receiver node transmits an ACK (Acknowledgement) signal to the transmitter node. If detecting an error in the received data, the receiver node does not transmit the ACK (Acknowledgement) signal to the transmitter node. At this time, an interception node intercepts the data transmitted from the transmitter node and stores the intercepted data in a data storage unit. And if not detecting the ACK (Acknowledgement) signal transmitted from the receiver node, the interception node retransmits the stored data to the receiver node. If detecting the ACK (Acknowledgement) signal, the interception node does not retransmit the stored data to the receiver node.

### CLAIM OF PRIORITY

The present application claims priority from Japanese application JP 2007-059381 filed on Mar. 9, 2007, the content of which is hereby incorporated by reference into this application.

### FIELD OF THE INVENTION

The present invention relates to a wireless communication system including plural nodes, as well as a communication method employed for the system. Particularly, the present invention relates to a communication method for enabling an interception node that intercepts data and control signals transmitted from a transmitter node to a receiver node. The interception node retransmits the intercepted data to the receiver node if a data error is detected in the data received by the receiver node from the transmitter node; the transmitter node does not retransmit the same data to the receiver node at this time. The present invention also relates to a communication system that employs the method.

### BACKGROUND OF THE INVENTION

There is a well-known conventional retransmission control method. According to this method employed for a conventional communication system, each frame includes an FCS (Frame Check Sequence) or CRC (Cyclic Redundancy Check) determination code and this code is used to detect data errors. Upon detecting such a data error, the receiver notifies the transmitter of the detected data error. And upon receiving the notification, the transmitter transmits the same data to the receiver again.

There is also another retransmission control method referred to as a stop & wait retransmission control method. According to this stop & wait retransmission control method, at first, the transmitter transmits one data frame, then the receiver checks the received data frame for frame error existence and feeds back an ACK/NACK signal to the transmitter, thereby the transmitter retransmits the same data if needed. Furthermore, there is still another retransmission control method referred to as a selective repeating retransmission control method. According to this method, at first, the transmitter transmits plural data frames and the receiver checks those frames for frame error existence collectively. Upon identifying a data error detected frame, the receiver notifies the frame to the transmitter, thereby the transmitter retransmits only the data error detected frame selectively to the receiver.

Hereunder, there will be described such a retransmission control method according to a conventional technique with reference to the accompanying drawings. FIG. 1 shows a configuration of a conventional wireless communication system with respect to a communication method employed for the system.

A node 104 is communicating with a server 101. The server 101 is connected to a base station 103 through a LAN (Local Area Network) and the base station converts each data received from the server 101 to wireless signals, then transmits the wireless signals to the node 104 as data signals.

The node 104 checks each received data frame for error existence. If not detecting any error in any received data, the node 104 notifies the base station of an ACK signal as a transmission confirmation response. If detecting an error in any received data, the node 104 does not transmit any signal or transmits a NACK signal to the base station 103.

If not receiving any ACK signal within a certain time or if receiving a NACK signal, the base station 103 retransmits the same data signals to the node 104 frame by frame.

Next, there will be described an example of a conventional wireless LAN system with reference to a retransmission control flow shown in FIG. 2.

At first, while a wireless LAN communication is made around the base station 103 and the node 104, both the base station 104 and the node 104 are in the busy status in which the communication between them is prohibited.

The base station 103, upon exiting this busy status, awaits for a DIFS (Distributed InterFrame Space) period. At the time of the first transmission, the base station 103 generates a uniform random number within a range of CW (Contention Window) between 0 and 15 and stores the random number obtained here (e.g., 3) as a back-off counter value.

When the DIFS period is over, the base station 103 counts down the value of the back-off counter at each predetermined time (slot time). If any data is received from another base station/node, the base station cancels the count-down and goes into the busy status. If no data is received from any other base station/node, the base station 103 can begin transmission of data signals to the node 104 when the back-off counter is reset to 0.

The node 104 then makes a CRC check to see if any error is included in the received data. If no error is detected, the node 104 receives the data signals, then transmits an ACK signal to the base station 103 after a SIFS (Short Inter Frame Space) period. If any error is detected in the frame data, the node 104 does not transmit any ACK signal or transmits a NACK signal explicitly to notify the base station 103 of the error detection.

If the base station 103 cannot receive any ACK signal even after an SIFS period after finishing transmission of data signals or if the base station 103 receives a NACK signal and recognizes a data error in any data received from the node 104, the base station 103 begins data retransmission.

At this time, the base station 103 awaits until a DIFS period is over, then resets the back-off counter to 0. The random number generation range CW makes a binary increment for each data retransmission so as to avoid packet collisions with other nodes. If the base station generates a uniform random number within a range of 0 to CW at the time of the n-th retransmission, the CW can be represented in the equation 1 as follows.

CW=(CWmin+1)×2ⁿ−1 [Equation 1]

Here, CWmin=15 is premised. When the CW reaches 1023 that is the maximum value (CWmax), the base station 103 attempts retransmission within the range of the maximum retransmission count, that is, M times at CW=1023. When M times of transmission is finished, the base station 103 discards subsequent frames. Upon this frame discarding, if the frame error rate exceeds a certain value, the transmission rate is controlled so as to be lowered.

If the frame error rate stays over a predetermined threshold value even after the transmission rate is lowered such way, control is made to change the communication route to another. And until the control works and the communication status is stabilized, frame errors come to occur consecutively.

### SUMMARY OF THE INVENTION

In the wireless communication system described above, the retransmission control is repeated until the line quality between the base station and the subject node is stabilized if it has been unstable.

In the conventional wireless LAN system, the uniform random number generation range that determines the back-off counter value increases in accordance with the equation 1 so as to avoid packet collisions, thereby a longer waiting time (back-off time) is required until the back-off counter is counted down at each slot time and reset to 0. And this requires a longer data delay time and this has been a problem. This is why the conventional system cannot meet the requirements of real time processing application programs.

If a data error cannot be recovered by such retransmission control, other means such as transmission rate control, route change control, etc. are required. And it is premised here that frame errors will occur continuously in each transition state in which control goes to such transmission control or route change control.

For example, in case of an application program for looking at and listening to real time video streaming at a node, the video is often disturbed by frame errors and aural-video synchronization errors occur at the time of route changing. These have also been problems.

Under such circumstances, it is an object of the present invention to provide a wireless communication system capable of reducing data errors that might occur during retransmission controlled by an interception node that intercepts data and control signals in communications between a transmitter node and a receiver node. The system includes a base station, a node, and an interception node.

A node means a terminal used by its user. The interception node and the node may be the same. If the base station transmits data to a node, the base station functions as a transmitter node and the node functions as a receiver node. On the contrary, if a node transmits data to the base station, the node functions as a transmitter and the base station functions as a receiver.

In order to achieve the above object, in the wireless communication system of the present invention, the transmitter node transmits a wireless signal including data and the receiver node receives the wireless signal from the transmitter node and checks the data included in the received wireless signal for error existence. If not detecting any error, the receiver node transmits a transmission confirmation response (ACK signal) to the transmitter node. If detecting an error in the data, the receiver node does not transmit the transmission confirmation (ACK signal). The interception node intercepts data transmitted from the transmitter node to the receiver node and stores the intercepted data in a storage unit. And if not detecting the transmission confirmation (ACK signal) transmitted from the receiver node, the interception node retransmits the stored data to the receiver node. If detecting the transmission confirmation response (ACK signal) transmitted from the receiver node, the interception node does not retransmit the stored data to the receiver node.

The transmitter node of the present invention for exchanging data with the receiver node includes a unit that adds a code to each received data to form a data frame, the code being used to check each received data for error existence; a unit that stores the data frame to prepare for retransmission; a unit that modulates the data frame to wireless signals, then transmits the wireless signals; a unit that detects data retransmitted from the interception node which retransmits data if detecting any transmission confirmation response from the receiver node; and a unit that controls a retransmission timing including retransmission of data according to the result of determination of retransmission.

The receiver node of the present invention, which exchanges data with the transmitter node, includes a unit that receives wireless signals, demodulates the wireless signals to data, then decodes the demodulated data to form a data frame; a unit that checks the data frame for data error existence; and a unit that transmits a transmission confirmation response (ACK signal) if not detecting any data error in the data frame.

The interception node of the present invention includes a unit that intercepts wireless signals exchanged between the transmitter node and the receiver node, modulates those wireless signals to data, then decodes the demodulated data to form a data frame; a unit that checks the data frame for data error existence; a unit that stores normal data frames; a unit that determines a retransmission request received from the receiver node; a unit that controls a retransmission timing for retransmitting stored data to the receiver node; and a unit that demodulates the data frame to be retransmitted to wireless signals and transmits the wireless signals.

The functions of the transmitter node are not provided only for the base station; they may also be provided for the node. Similarly, the functions of the receiver node are not provided only for the node; they may also be provided for the base station.

The interception node can use any of the following four methods (1) to (4) to determine a timing for retransmitting a data frame on behalf of the transmitter node.

(1) Upon confirming a retransmission request, the interception node awaits for a certain preset period, which is the same as that of the transmitter node, then generates a uniform random number within a smaller range than that of the transmitter node after the preset period is over. The interception node, which counts a certain period as one slot time, then awaits until the number of counted slots reaches the obtained random number and confirms that no retransmission is made from any of the transmitter node and near-by interception nodes during the waiting period, then retransmits the subject data frame.
(2) Upon confirming a retransmission request, the interception node awaits for a shorter period than a preset certain period during which the transmitter node must awaits, then counts the number of slots in the period during which the transmitter node must awaits and generates a uniform random number within a range denoted by the number of the counted slots. After this, the interception node counts a certain period as one slot time and awaits until the number of the counted slots reaches the obtained random number and confirms that no transmission is made from the transmitter node, as well as from any near-by interception nodes during the waiting period. Then, the interception node begins retransmission.
(3) Upon confirming a retransmission request, the interception node awaits for a shorter period than a preset certain period during which the transmitter node must awaits, then generates a uniform random number within a smaller range than that of the transmitter node. The interception node, which counts a certain period as one slot time, awaits until the number of counted slots reaches the obtained random number, then confirms that no retransmission is made from the transmitter node, as well as from any near-by interception nodes during the waiting period. Then, the interception node begins retransmission.
(4) Upon confirming a retransmission request, the interception node awaits for a shorter period than a preset certain period during which the transmitter node must awaits, then counts the number of slots in a period during which the transmitter must await and measures a receiving power (RSSI) upon receiving a retransmission request signal from the receiver node. A receiving power (RSSI) value, assigned beforehand so as to be transmitted in a descending order, is set in each of the slots. Thus retransmission by the interruption is enabled in each slot of which assigned value is exceeded by the measured value of the receiving power (RSSI).

According to an aspect of the present invention, even when the wireless communication between the transmitter node and the receiver node is unstable, if the wireless communication between an interception node and the receiver node is stable, the interception node that intercepts the data exchanged between the transmitter node and the receiver node retransmits the data interrupted and stored by itself to the receiver node, thereby reducing the data error occurrence in the receiver node.

Particularly, the wireless LAN system is provided with a function for lowering the packet collision possibility by delaying the transmission timing so as to avoid such packet collisions that might occur among retransmitted packets and increase in proportion to an increase of the number of times of retransmission. In case of the present invention, however, an interception node can retransmit data to the receiver node preferentially, thereby the interception node can control retransmission without increasing the delay time as described above.

### BRIEF DESCRIPTION OF THE DRAWINGS

FIG. 1 is a configuration of a wireless communication system;

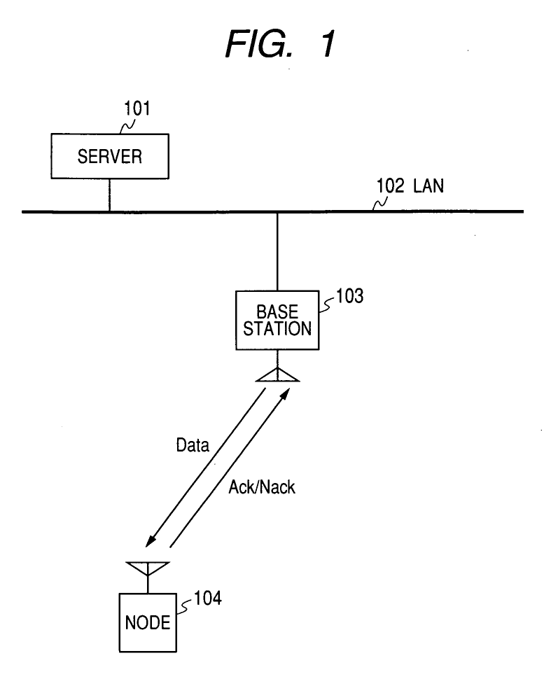

FIG. 2 is a diagram for describing a retransmission control flow of the wireless communication system;

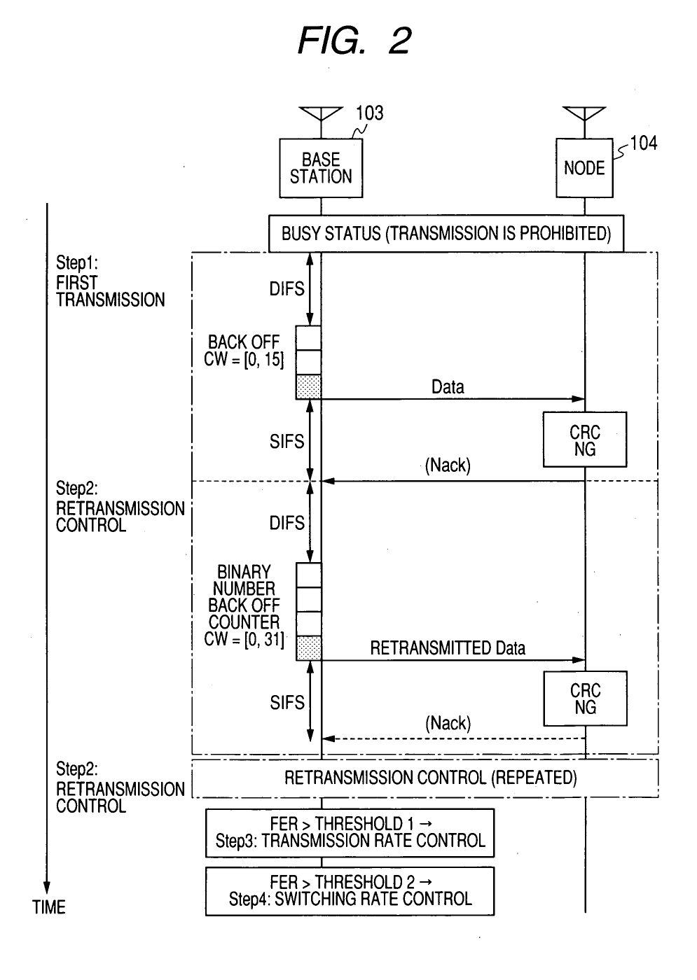

FIG. 3 is a diagram for describing a configuration of a wireless communication system of the present invention, as well as a communication method employed for the system;

FIG. 4 is a diagram for describing a retransmission control flow in a first embodiment of the present invention;

FIG. 5 is a diagram for describing a retransmission control flow in a second embodiment of the present invention;

FIG. 6 is a diagram for describing a retransmission control flow in a third embodiment of the present invention;

FIG. 7 is a diagram for describing a problem of packet collisions that might occur among plural interception nodes in an embodiment of the present invention;

FIG. 8 is a diagram for describing a method for solving the packet collisions in the embodiment of the present invention;

FIG. 9 is configurations of a base station, a node, and an interception node in the embodiment of the present invention;

FIG. 10 is a diagram for describing an algorithm employed for the processings of a transmitter control part in the embodiment of the present invention;

FIG. 11 is a diagram for describing an algorithm employed for the processings of a receiver control part in the embodiment of the present invention;

FIG. 12 is a diagram for describing an algorithm employed for the processings of an interception control part in the embodiment of the present invention;

FIG. 13 is formats of NACK, ACK2, NACK2, ACK3, and NACK3 signals in the embodiment of the present invention;

FIG. 14 is data frame formats in the embodiment of the present invention;

FIG. 15 is a diagram for describing a retransmission control flow in a fourth embodiment of the present invention;

FIG. 16 is a diagram for describing a route change control flow that uses an interception node in the embodiment of the present invention;

FIG. 17 is a diagram for describing a route change control flow that changes from a route that uses an interception node to a route that does not use any interception node in the embodiment of the present invention; and

FIG. 18 is a diagram for describing the effects in the embodiment of the present invention.

### DETAILED DESCRIPTION OF THE PREFERRED EMBODIMENTS

Hereunder, there will be described the preferred embodiments of a wireless communication system of the present invention with reference to the accompanying drawings.

### First Embodiment

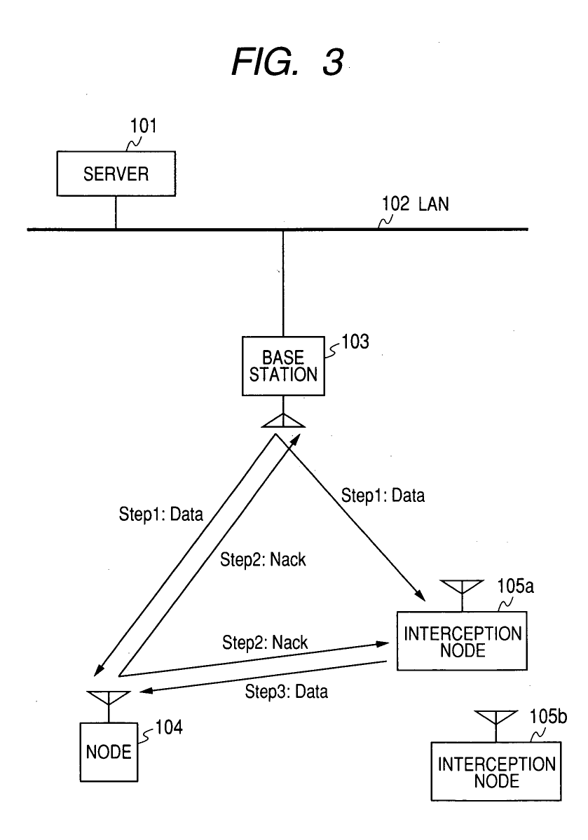

FIG. 3 shows a configuration of a wireless communication system with respect to a communication method in an embodiment of the present invention.

A node 104 is communicating with a server 101. The server 101 connected to a base station 103 through a LAN (Local Area Network) 102 converts data received from the server 101 to wireless data signals and transmits the data signals to the node 104 (step 1). At this time, an interception node 105a also receives the data signal transmitted from the base station 103 and checks the received data for error existence. If no error is detected in the received data, the interception node 105a stores the data in a buffer.

The node 104 checks received data for error existence. If no error is detected in the received data, the node 104 transmits an ACK signal as a transmission confirmation response to the base station 103. If any error is detected in the received data, the node 104 does not transmit anything or notifies the base station 103 of a NACK signal (step 2). The interception node 105a, if not receiving the ACK signal within a certain period or if receiving a NACK signal, retransmits the stored data signal to the node 104 on behalf of the base station 103 if it is determined to be better to do so (step 3).

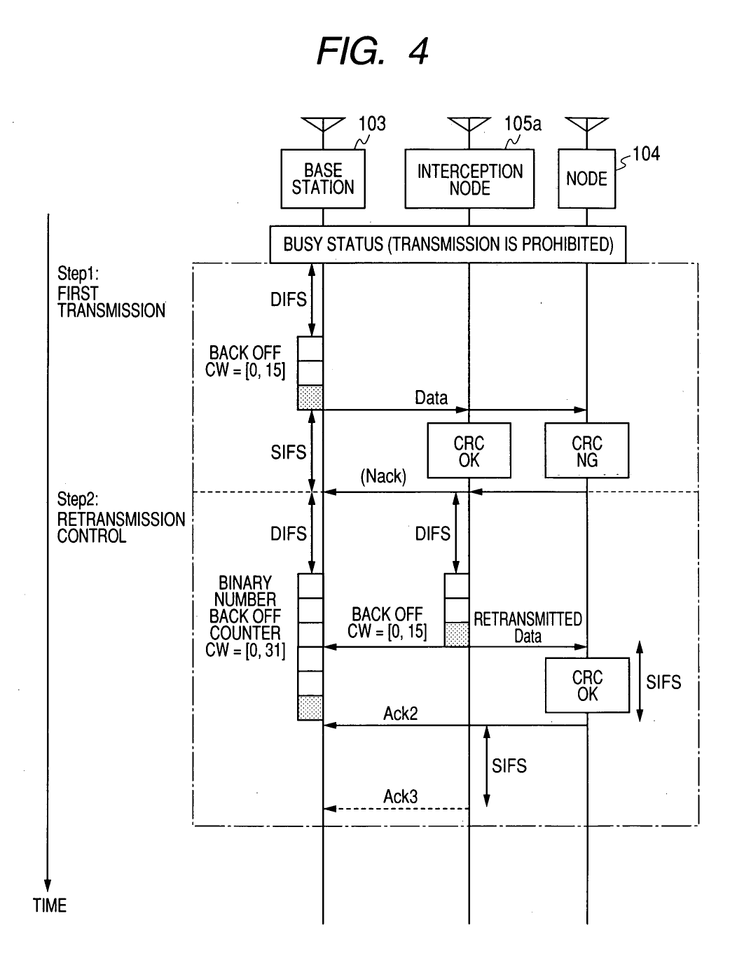

FIG. 4 shows a diagram for describing a retransmission control flow in this first embodiment of the present invention.

At first, while a wireless communication is made in the neighborhood, the base station 103, the node 104, and the interception node 105a are all in the busy status (prohibited for transmission).

The base station 103, when existing this busy status, awaits for a DIFS period, then generates a uniform random number within a range of 0 to 15 (CW: Contention Window) at the first transmission time to determine a back-off counter, thereby determining a transmission timing. The base station 103 is enabled for transmission if no transmission status is detected in the neighborhood for a slot period as long as the back-off counter value.

It is premised here that a frame error is detected by the node 104 that has checked the CRC and no frame error is detected in the interception node 105a. At this time, the node 104 does not transmit any ACK signal even after the SIFS period is over or transmits a NACK signal, thereby notifying the base station 103 of the frame error occurrence.

The base station 103 then awaits for a DIFS period to determine a retransmission timing and furthermore to determine a transmission timing within a random number range to be determined by the equation 1 at the time of retransmission. At the second retransmission time, the uniform random number range is between 0 to 31 and the base station 103 comes to await for a 31/2=15.5 slot period that is an expected value.

On the other hand, the interception node 105a knows occurrence of a frame error in the node 104 by receiving no ACK signal even after the SIFS period is over or by receiving a NACK signal. And the interception node 105a, exiting the DIFS period waiting status, generates a uniform random number between 0 and 15 just like the first transmission time and stores the number as a back-off counter value and awaits for a slot period as long as the counter value.

Because the expected value in this case is 15/2=7.5, the back-off counter value becomes smaller probabilisticly than that of the base station 103, thereby the retransmission by the interception node 105a is enabled preferentially than the base station 103.

The node 104, upon receiving retransmitted data, checks the data for error existence. If no error is detected in the data, the node 104 notifies the interception node 105a of an ACK signal denoting the success of the retransmission by the interception node 105. If an error is detected in the retransmitted data, the node 104 does not transmit anything or notifies the interception node 105 of a NACK2 signal.

Upon receiving the ACK2 signal, the base station knows the success of the retransmission by the interception 105, then discards the data stored to prepare for retransmission and begins the next data frame transmission. If receiving the NACK2 signal, the base station 103 knows the failure of the retransmission by the interception node 105, then goes to the retransmission process.

If the wireless communication between the base station 103 and the node 104 is unstable, the base station 103 might not receive any of the ACK2 and NACK2 signals from the node at a high possibility. In such a case, therefore, those ACK2 and NACK2 signals are transmitted with use of a modulation method (e.g., BPK modulation method) of which transmission rate is lower than that used for data signals, thereby improving the receiving possibility.

If the interception node 105a receives an ACK2 signal, the interception node 105a awaits for an SIFS period, then transmits an ACK3 signal to the base station 103. If receiving a NACK2 signal, the interception node 105 awaits for an SIFS period, then transmits a NACK3 signal to the base station 103, thereby the interception node 105a can relay the success/failure of receiving retransmitted data from the node 104 to the base station 103.

If receiving an ACK2 or ACK3 signal, the base station 103 knows retransmission made by the interception node 105a, thereby the base station 103 can transmit the next data signal to the node 104.

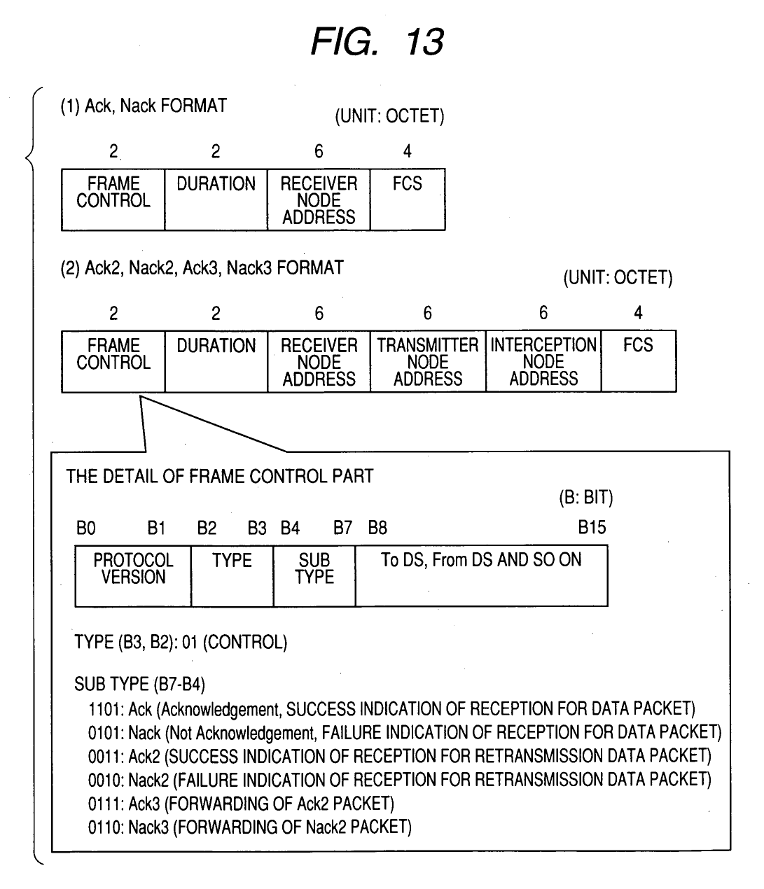

FIG. 13 shows a frame format of the ACK and NACK signals in (1) and a frame format of the ACK2, ACK3, and NACK2, and NACK3 signals in (2). These formats are also used similarly in the second and third embodiments respectively.

These formats are obtained by extending the wireless LAN standards. In addition to those formats, any other formats may be used if they include identifiers and address information of the control signals to be described later.

At first, as for the identifiers of control signal types, one of the ACK2, ACK3, NACK2, and NACK3 is assigned in the frame control sub-type field. As for the NACK signal, the base station that has transmitted the NACK signal receives the signal after an SIFS period, so that it is just required to set the subject receiver node address information in the format. As for the ACK2, ACK3, NACK2, and NACK3 signals, in addition to the receiver node address, the transmitter node and interception node addresses are also set in the format so as to distinguish among retransmission collisions by the base station and by the interception nodes.

In the example of the ACK2 signal transmitted from the node 4 shown in FIG. 4, the address of the node 104 is set in the receiver node address field, the address of the base station 103 is set in the transmitter node address field, and the address of the interception node 105a is set in the interception node address field. Each address information is also set similarly for the NACK2 signal.

The base station 103, if receiving an ACK2 signal (or a NACK signal), checks to see if the transmitter address is the same as its own one, thereby knowing success/failure of the retransmission by the interception node 105a.

The interception node 105a, if receiving an ACK2 (or NACK2) signal, checks the interception node address to know the success/failure of the retransmission, thereby transmitting an ACK3 (or NACK3) signal in accordance with the result. In this case, the ACK3 (or NACK3) address signal is set just like the ACK2 (or NACK2) signal.

If the base station 103 retransmits data earlier than the interception node 105a, the node 104 is just required to return an ACK (or NACK) signal in a conventional way.

The node 104 may also return an ACK2 or NACK2 signal at this time. In this case, no information is set in the interception node address field; instead, a value of all 1's or all 0's is set therein. At this time, even if receiving an ACK2 signal, the interception node 105a does not transmit an ACK3 (or NACK3) signal. This is because the ACK2 is not issued for the data retransmitted by the interception node 105a.

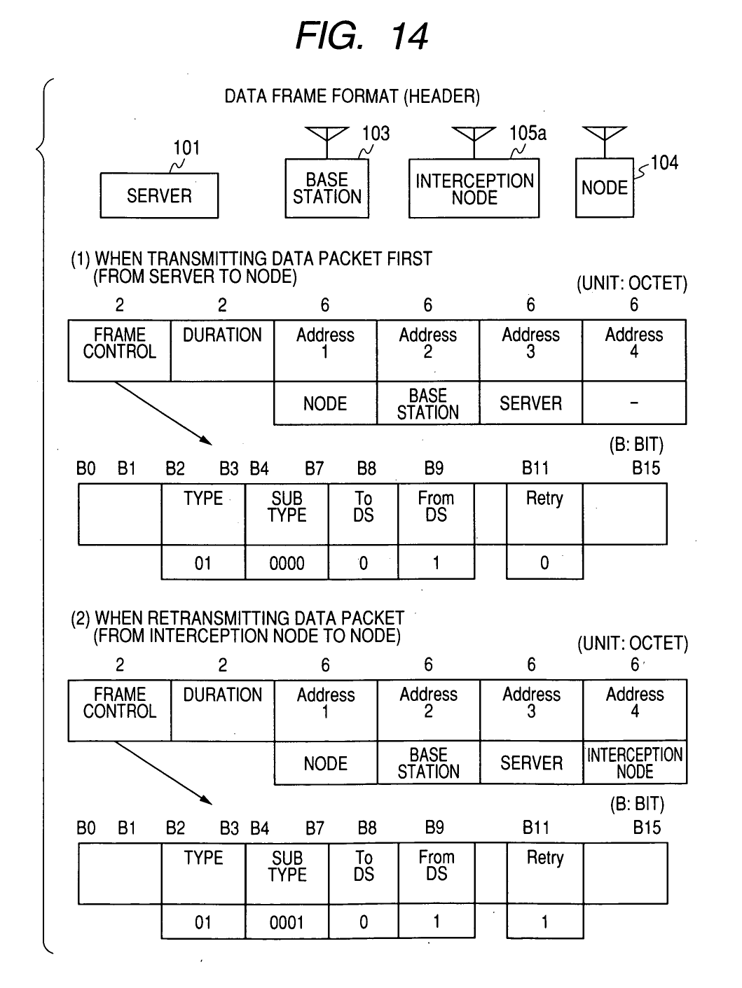

FIG. 14 shows a configuration of the header part of the data frame.

At the first transmission from the base station 103 to the node 104, the address of the destination node 104 is set in the Address1 field, the address of the base station 103 is set in the Address2 field, and the address of the server is set in the Address3 field respectively.

In the data frame used for retransmitting data from the interception node 105 to the node 103, a type of retransmission by an interception node 105 to the node 104 is defined newly in the sub-type field of frame control and 1 is set in the Retry bit for representing retransmission.

In the Address1 to Address3 fields, the same addresses as those at the first transmission time are set. In the Address4 field that is not used, the address of the interception node 105 is set. Consequently, the node 104 can obtain the address of the interception node 105 and the address of the base station 103 upon generating the ACK2 and NACK2 signals.

As described above, in the wireless system of the present invention, the interception node 105 may obtain data to be transmitted from the transmitter node as any of wireless signals and wired signals. Concretely, if the interception node is connected to the server through a wired network, the interception node may intercept wireless data to be transmitted from the base station 103 to the node 104 through the wired network.

The interception node may also retransmit the data obtained from the base station to the node through any of a wireless network and a wired network. Concretely, if the interception is connected to the node through a wired network, the interception node may retransmit data to the node through the wired network.

### Second Embodiment

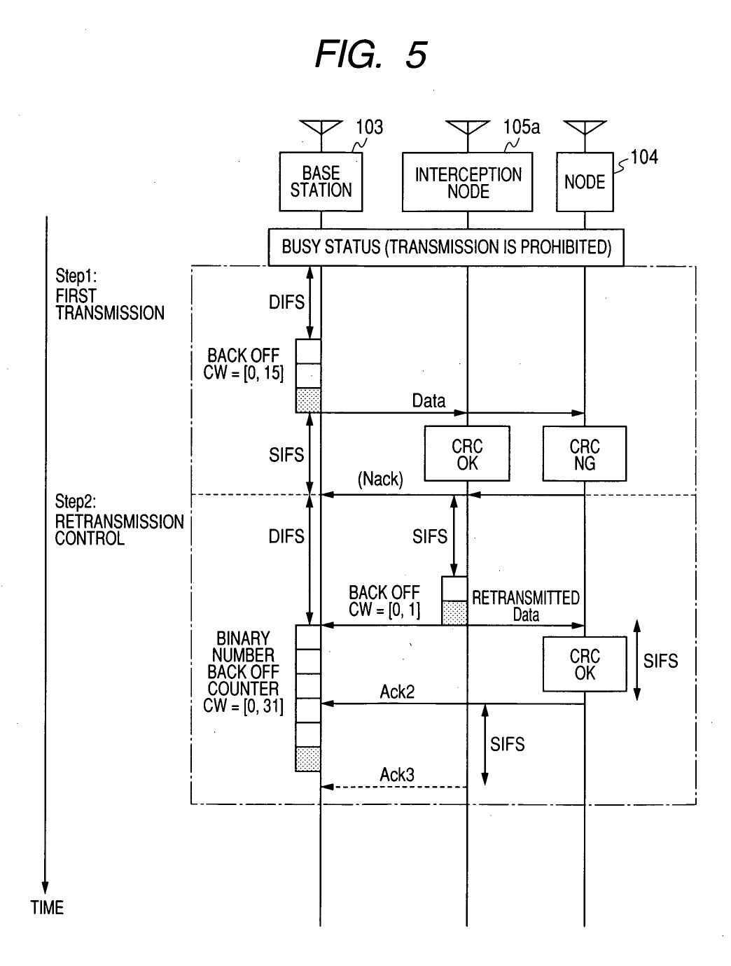

FIG. 5 shows a diagram for describing a retransmission control flow in a second embodiment of the present invention.

While a wireless communication is made in the neighborhood, the base station 103, the node 104, and the interception node 105a are all in the busy status in which their transmission is prohibited. The base station, upon exiting this busy status, awaits for a DIFS period, then generates a uniform random number within a random number generation range (CW: Contention Window) between 0 and 15 at the first transmission, thereby determining a transmission timing. If no transmission event is detected during this random number slot period, the transmission is enabled for the base station 103, the node 104, and the interception node 105a respectively.

It is premised here that a frame error is detected in the node 104 through a CRC check and no frame error is detected in the interception node 105a. At this time, the node 104 does not transmit any ACK signal even after an SIFS period is over or transmits a NACK signal, thereby notifying the base station 103 of the detected frame error.

The base station 103 then awaits for a DIFS period to determine a retransmission timing and furthermore determine a transmission timing within a random number range determined by the equation 1 at the first retransmission time. At the second retransmission, the random number becomes a uniform random number between 0 and 31 and the expectation value becomes a 31/2=15.5 slot period.

On the other hand, the interception node 105a might not receive any ACK signal even after the SIFS period is over or receive a NACK signal, so that the interception node 105a comes to know occurrence of a frame error in the node 104.

And in order to make retransmission with priority over the base station 103, the interception node 105a awaits for an SIFS period that is shorter than the DIFS period, then generates a uniform random number within a range of 0 to 1 and stores the random number as a back-off counter value. After this, the interception node 105a awaits for a slot time as long as this counter value. Because the difference between the SIFS period and the DIFS period is 2 slots, the interception node 105a can make retransmission surely with priority over the base station 103.

In order to make retransmission preferentially in competition with the base station 103, the interception node 105a awaits for an SIFS period, then generates a uniform random number in a range of 0 to 17 and stores the random number as a back-off counter value. After this, the interception node 105a awaits for a slot time as long as this counter value. In this case, the back-off counter expectation value increases by one to 17/2=8.5 in comparison with that in competition with the base station 103 as described with reference to FIG. 3. However, awaiting for the SIFS period is enough, so that the interception can begin transmission by moving forward by two slots of time. As a result, the retransmission by the interception node 105a takes precedence over the case shown in FIG. 3 at a higher possibility.

The node 104, upon receiving data retransmitted by an interception node 105, checks the data for error existence. If no error is detected in the data, the node 104 transmits an ACK2 signal to the interception node 105 to notify the success of the retransmission. If an error is detected in the retransmitted data, the node 104 transmits a NACK2 signal to the interception node 105.

If the wireless communication between the base station 103 and the node 104 is unstable, the base station 103 might not be able to receive the ACK2 and NACK2 signals from the node 104 at a high possibility. In order to avoid such a trouble, the ACK2 and NACK2 signals may be transmitted with use of the BPSK modulation method or the like to lower the transmission rate and improve the possibility for receiving. If the interception node 105a receives an ACK2 signal, the interception node 105a awaits for an SIFS period, then transmits an ACK3 signal. If receiving a NACK signal, the interception node 105a awaits for an SIFS period, then transmits a NACK3 signal to the base station 103, thereby the interception node 105a can notify the base station 103 of the success or failure of retransmission by the node 104 indirectly.

The base station 103, upon receiving an ACK2/ACK3 signal, can know the retransmission executed by the interception node 105a, thereby beginning transmission of the next data to the node 104.

### Third Embodiment

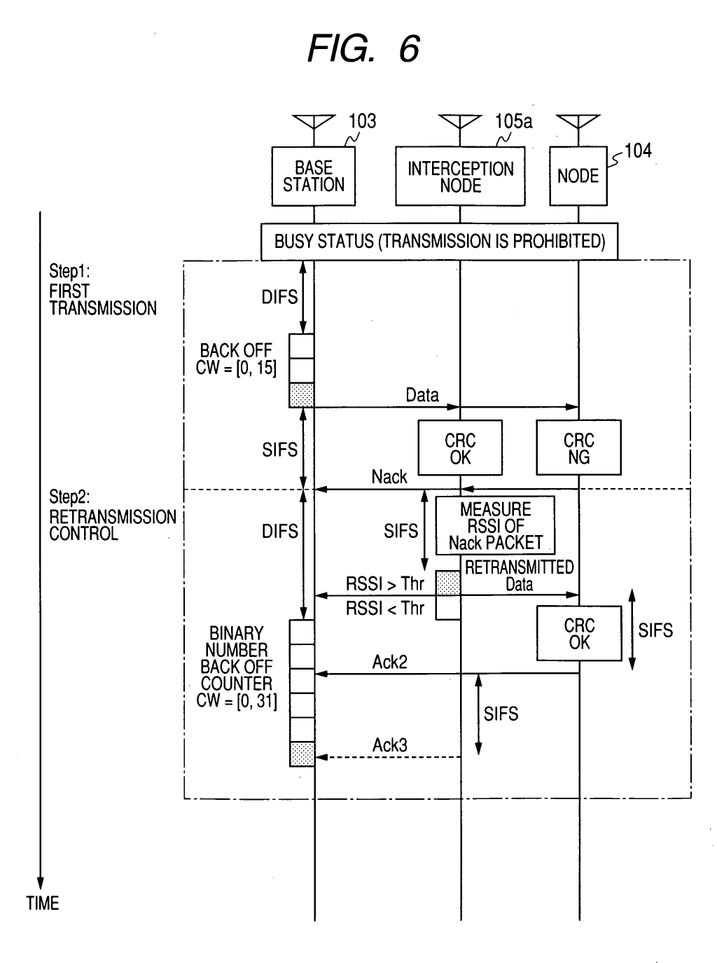

FIG. 6 shows a diagram for describing a retransmission control flow in a third embodiment of the present invention.

While a wireless communication is made in the neighborhood, the base station 103, the node 104, and the interception node 105a are all in the busy status in which their transmission is prohibited. The base station, upon exiting this busy status, awaits for a DIFS period, then generates a uniform random number within a range (CW: Contention Window) of random number generation between 0 and 15 at the first transmission, thereby determining a transmission timing.

If no transmission event is detected during this random slot period, the transmission is enabled for the base station 103, the node 104, and the interception node 105a respectively. It is premised here that a frame error is detected in the node 104 through a CRC check and no frame error is detected in the interception node 105a. At this time, the node 104 transmits a NACK signal to notify the base station 103 of the detected frame error.

Upon receiving the NACK signal, the base station 103 awaits for a DIFS period to determine a retransmission timing within a random number range determined by the equation 1 at the retransmission time. At the second retransmission, the random number becomes a uniform random number between 0 and 31 and the expectation value becomes a 31/2=15.5 slot period.

Upon receiving the NACK signal, the interception node 105a comes to know occurrence of a frame error in the node 104. And in order to make retransmission preferentially to the base station 103, the interception node 105a awaits for an SIFS period that is shorter than the DIFS period, determines a retransmission timing at the first or second slot before the DIFS period begins.

The retransmission timing will become as follows. At first, the NACK signal receiving power (RSSI: Received Signal Strength Indicator) is measured and if the measured RSSI value is over the threshold, data is retransmitted at the first slot. If the RSSI value is under the threshold, the data is transmitted at the second slot.

If the difference between the DIFS period and the SIFS period is 2 slots of time or over, plural threshold values are prepared, thereby those slots are assigned so as to set the retransmission timing earlier in proportion to an increase of the RSSI value. This is because it is expected that the receiving power of the node with respect to the signal transmitted from the interception node becomes larger in proportion to an increase of the measured RSSI value. Thus the possibility of retransmission success is expected to become higher.

Consequently, priority is given to the retransmission by the interception node having a higher measured RSSI value, thereby the retransmission efficiency is improved.

Also in this case, if competition with the base station 103 is enabled, it is possible to prepare plural slots to be assigned in accordance with the RSSI value respectively and assign an RSSI value to each of those slots, for example, 0 to 17 to determine a retransmission timing.

The node 104, upon receiving data retransmitted by the interception node 105a, checks the data for error existence. If no error is detected in the data, the node 104 transmits an ACK signal to the interception node 105a to notify the success of the retransmission by the interception node 105a. If not detecting any error in the retransmitted data, the node 104 transmits a NACK2 signal to the interception node 105a.

If the wireless communication between the base station 103 and the node 104 is unstable, the base station 103 might not be able to receive the ACK2 and NACK2 signals from the node 104 at a high possibility. In order to avoid such a trouble, the ACK2 and NACK2 signals may be transmitted with use of the BPSK modulation method or the like to lower the transmission rate and improve the receiving possibility.

If receiving an ACK2 signal, the interception node 105a awaits for an SIFS period, then transmits an ACK3 signal. If receiving a NACK2 signal, the interception node 105a awaits for an SIFS period, then transmits a NACK3 signal to the base station 103, thereby notifying the success or failure of retransmission by the node 104 indirectly.

The base station 103, upon receiving an ACK2/ACK3 signal, can know retransmission executed by the interception node 105a, thereby beginning transmission of the next data to the node 104.

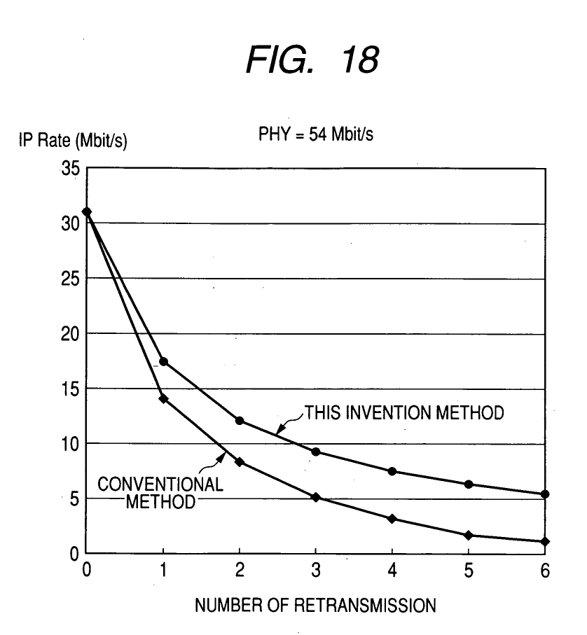

FIG. 18 shows a result of comparison between retransmission by present invention and conventional retransmission carried out with use of the wireless LAN IEEE802.11a. The physical layer transmission rate is assumed to be 54 Mbits/s and the comparison is made by showing the number of retransmission times on the horizontal axis with respect to the effective rate in the IP layer when in communications at a rate of IP packet 1500 bytes. As the number of retransmission times increases, the effective rate is lowered due to an increase of the delay time in case of the conventional technique. In case of the present invention, however, it is understood that the effective rate is less lowered.

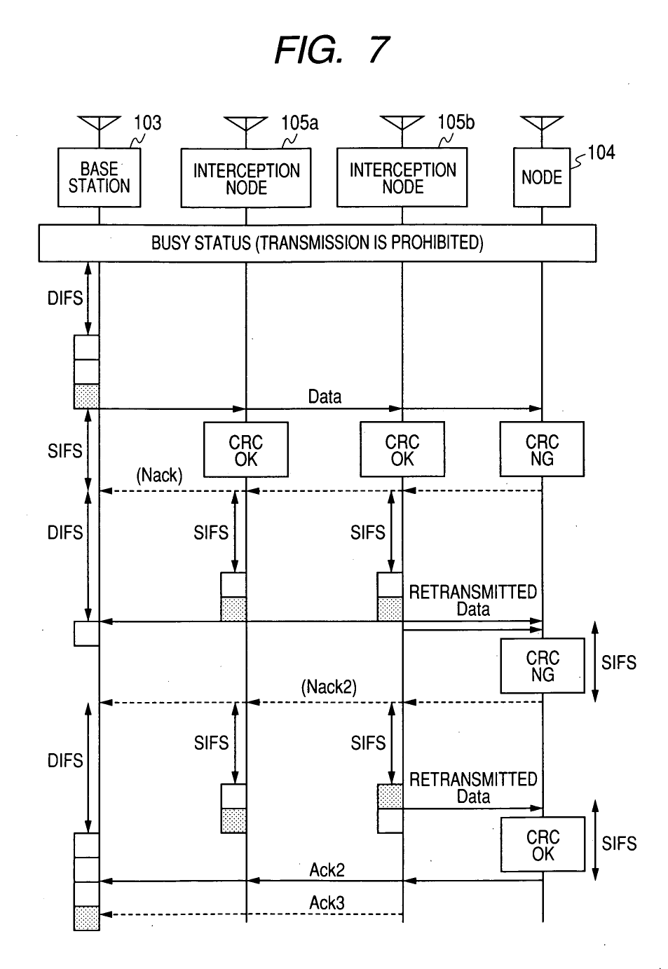

Next, there will be described a problem of packet collisions that might occur among plural interception nodes with reference to FIG. 7. This problem is common to the first to third embodiments of the present invention.

If a frame error occurs in any data transmitted from the base station 103 and received by the node 104, the node 104 does not transmit an ACK signal even after an SIFS period is over or transmits a NACK signal to the base station 103 to notify the frame error.

At this time, if plural interception nodes 105a and 105b retransmit data at the same slot time, a frame error might occur again in the node 104 due to a packet collision.

If any retransmitted data cannot be decoded in the node 104, the node 104 cannot transmit the NACK signal. In this case, therefore, an interception node (e.g., 105b) determines a retransmission timing again. As a result, if the interception node 105b comes to retransmit data earlier than the interception node 105a, the node 104 can receive the correct retransmitted data.

In the second and third embodiments of the present invention, if a competition occurs between the interception nodes 105a and 105b only in the two slots of time, which is a difference between DIFS and SIFS periods, a packet collision might occur at a high possibility. This is why there has been demanded an effective method for reducing such packet collisions.

This problem might also occur in the first embodiment of the present invention, since a packet collision occurs even when both the base station 103 and an interception node 105 retransmit data at the same timing in the same slot.

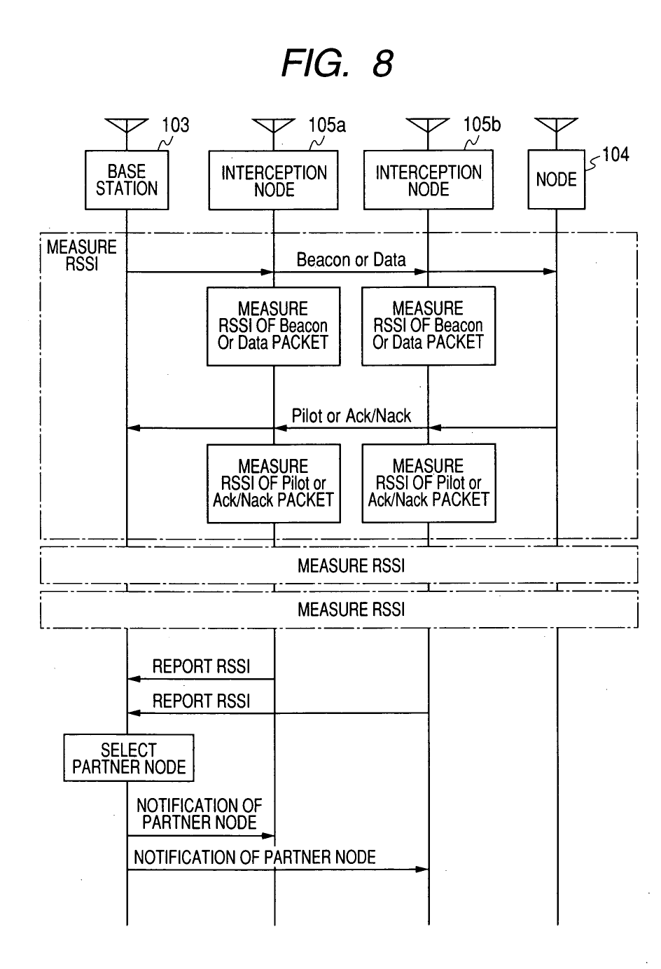

Next, there will be described a method for solving such a packet collision that is common to the first, second, and third embodiments of the present invention with reference to FIG. 8.

One of the effective methods for solving the above packet collision problem is not to determine an interception node used for retransmission at each time of communication, but to determine an interception node as a specified partner to be employed for retransmission by searching such interception nodes that will be usable for retransmission beforehand and by enabling only one of those specified interception nodes to retransmit data when in necessary, thereby reducing packet collision occurrence.

Here, there will be described how to determine such a partner interception node.

If the base station 103 is transmitting a beacon signal periodically, each of the interception nodes 105a and 105b measures the beacon signal receiving power RSSI. Otherwise, the base station 103 measures the receiving power RSSI of the data signal transmitted to the node 104.

If the node 104 is transmitting a pilot signal periodically, each of the interception nodes 105a and 105b measures the receiving power RSSI of this pilot signal. Otherwise, the node 104 measures the receiving power RSSI of the ACK or NACK signal to be returned to the base station 103.

Each of the interception nodes 105a and 105b repeats those RSSI measurements by the number of predetermined times and notifies the base station of the measurement result as a control message referred to as an RSSI report. The base station 103 determines its partner according to this RSSI measurement result.

It is also possible here to determine an interception node as such a partner if the interception node has the largest value of the average values, the maximum values, or the minimum values of the received RSSI measurement values of the interception nodes with respect to the pilot signal or ACK/NACK signal transmitted from the node 104.

It is also possible here to determine an interception node as such a partner if the interception node has the largest value of the average values, the maximum values, or the minimum values of the interception nodes selected by checking the difference between the received RSSI value at each interception node with respect to the pilot signal transmitted from the node 104 and the received RSSI value at each interception node with respect to the beacon signal transmitted from the base station 103.

It is also possible here to determine an interception node as such a partner if the interception node has the largest value of the average values, the maximum values, or the minimum values of the interception nodes selected by checking the difference between the received RSSI value at each interception node with respect to the ACK or NACK signal transmitted from the node 104 and the received RSSI value at each interception node with respect to the data signal transmitted from the base station 103.

Furthermore, it is also possible here to determine an interception node as such a partner if the interception node satisfies a condition that a predetermined threshold value is exceeded by the average, maximum, or minimum value of the received RSSI measurement values at the interception nodes with respect to the beacon signal or data signal transmitted from the base station 103.

While the receiving power RSSI is used in the example shown in FIG. 8, the measured transmission loss between the base station 103 and the interception node 105a/105b, as well as the measured transmission loss between the interception node 105a/105b and the node 104 may also be used to determine such a partner instead of the RSSI.

The transmission loss between the base station 103 and the interception node 105a/105b may be obtained from a difference between the transmission power of the beacon signal transmitted from the base station 103 and the receiving power of the beacon signal received by the interception node 105a/105b. The transmission loss may also be obtained from a difference between the transmission power of the data signal transmitted from the base station 103 and the receiving power of the data signal received by the interception node 105a/105b.

The transmission loss between the interception node 105a/105b and the node 104 may be obtained from a difference between the transmission power of the pilot signal or ACK/NACK signal transmitted from the node 104 and the receiving power of the pilot signal or ACK/NACK signal received by the interception node 105a/105b.

While the transmission power of the base station 104 with respect to a data signal/beacon signal (transmission signal), if it is already known by the base station 103, can be obtained from a report of the receiving power (RSSI) measurement at an interception node. If a transmission power control method that uses a transmission signal power that changes with time is employed, the transmission power information can be included in the transmission signal and the transmission power value is related to the receiving power (RSSI) at the subject interception node, thereby obtaining such a transmission loss.

Similarly, if the base station 103 already knows the transmission power of each of the pilot signal and the ACK/NACK signal (transmission signal) transmitted from the node 104 and the transmission power is fixed, the transmission loss can be obtained from a report of the receiving power (RSSI) measurement at the subject interception node.

However, if a transmission power control method that uses a transmission signal power that changes with time is employed, the transmission power information can be included in the transmission signal and the transmission power value is related to the receiving power (RSSI) at the subject interception node, thereby obtaining such a transmission loss.

If such a transmission loss is used to determine a partner interception node, it is possible to select an interception node having the minimum transmission loss between the node and each interception node.

Furthermore, it is also possible to select an interception node as such a partner if the interception node has a transmission loss that is the minimum of those values between the node and each interception node and under a predetermined threshold value.

If the base station 103 determines its partner, the base station 103 notifies each interception node of the selected interception node as the partner with a control message referred to as partner notification. This control message includes the partner's address.

If the base station 103 cannot find a partner, the base station 103 notifies each interception node of the effect by specifying all-1 or all-0 address information or by setting the “no partner” bit. If the bit used not to identify a partner specially is set to notify each interception node of “no partner selected”, all the interception nodes come to compete in transmission.

If a bit is set so as not to operate the functions of any interception nodes, all those interception nodes are prohibited to make retransmission.

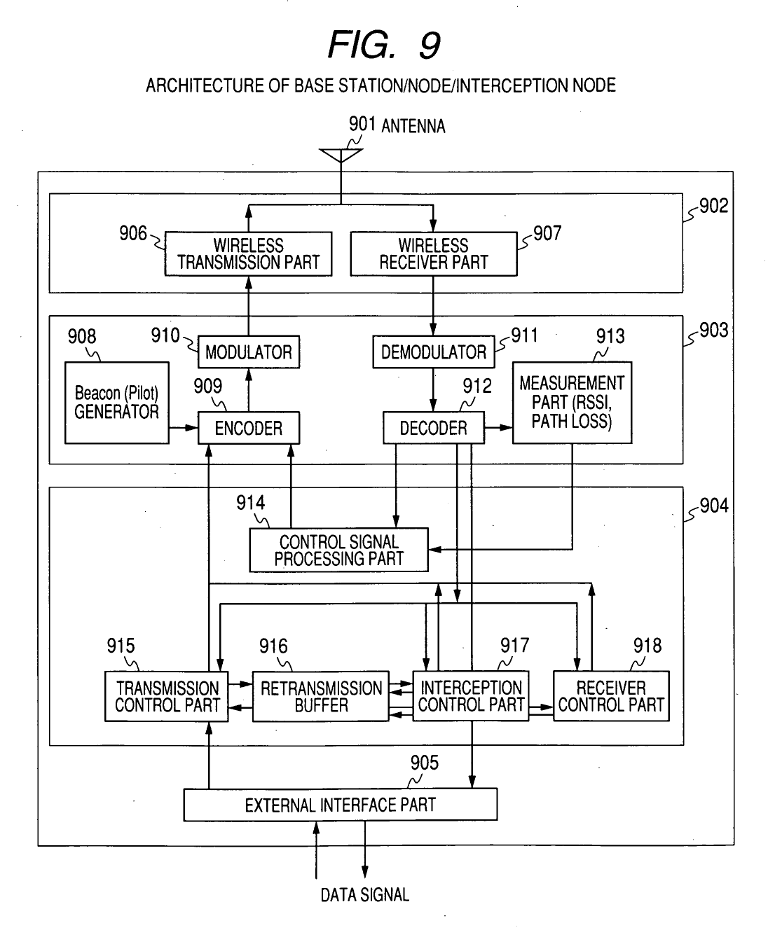

Next, there will be described configurations of the base station, the node, and the interception nodes common to the first, second, and third embodiments of the present invention with reference to FIG. 9.

In each of the first, second, and third embodiments, it is premised that the base station, the node, and the interception nodes are all the same in configuration. Thus each of those units functions as the base station, a node, or an interception node according to where it is positioned or how it is used. The configuration of the unit is roughly divided into an antenna 901, a wireless unit 902, a baseband signal processing unit, a control unit 904, and an external interface 905.

The antenna 901 transmits/receives wireless signals and the external interface 905 transmits/receives data mainly to/from a wired Ethernet.

The wireless unit 902 includes a wireless receiver part 907 for amplifying received wireless signals, converting a wireless signal band to a baseband signal processing band, and converting analog signals to digital signals; and a wireless transmission part 906 for amplifying and filtering signals transmitted from the baseband signal processor 903 and converting digital signals to analog signals.

The baseband signal processor 903 includes a beacon (pilot) generator 908 for generating a beacon signal (base station) and a pilot signal (nodes) periodically; an encoder for multiplexing the beacon and pilot signals, as well as data signals and control signals transmitted from the control unit 904 to encode those signals with use of a wireless system standard and modulate those signals; a modulator 910; and a demodulator 911 for demodulating signals received by the wireless unit 902 and decode those signals in accordance with the wireless standards; a decoder 912; and measurement part 913 for measuring the receiving power (RSSI) or transmission loss according to the beacon or pilot signal and data signals received from another base station/node.

The control unit 904 includes a control signal processing part 914 for processing the control signals used, for example, to determine an interception node as a partner in accordance with a predetermined protocol; a transmission control part 915 for determining data transmission and retransmission timings as a transmitter node; a retransmission buffer 916 for storing data to be retransmitted; an interception control part 917 for determining retransmission timings as an interception node; and a receiver control part 918 for executing retransmission as a receiver node.

Each of the base station, the interception node, and the node does not require all of those devices and parts as described above; it may be composed of only required items.

For example, if the interception node does not require any functions of the base station and the node, the interception node may exclude the transmission control part 915, the receiver control part 918, and the external interface part 905 from its configuration.

Similarly, if the base station does not require any functions of the interception node and the node, the base station may exclude the interception control part 917 and the receiver control part 918 from its configuration.

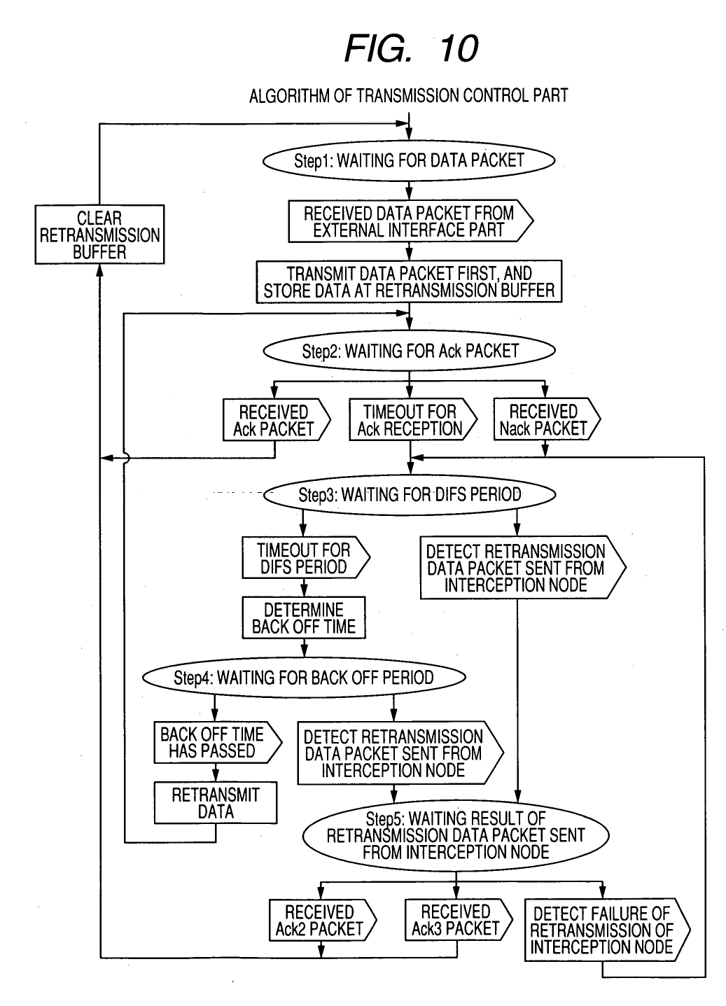

Next, there will be described an algorithm used for the processings of the transmission control part 915 in the first to third embodiments of the present invention with reference to FIG. 10.

The transmission control part 915 waits for data transferred from the external interface part 905 in its initial state (step 1).

Upon inputting a data signal, the transmission control part 915 begins the first data transmission according to the wireless protocol as described with reference to FIG. 4. Concretely, the transmission control part 915 exits the busy status and awaits for a DIFS period, then sets a back-off counter. If no communication is detected in its neighborhood by the slot time in which counting-down is finished in a back-off counter, the transmission control part 915 can begin data transmission. At this time, the transmission control part 915 stores data to be transmitted in the retransmission buffer 916.

After this, the transmission control part 915 goes to step 2 to wait for receiving an ACK signal from the node 104.

If receiving an ACK signal, the transmission control part 915 regards it as notification of the success of the subject data transmission. Thus the transmission control part 915 returns to step 1 to wait for receiving the next data. If the transmission control part 915 does not receive an ACK signal even after a predetermined period is over (timeout) or the transmission control part 915 receives a NACK signal clearly, the transmission control part 915 goes to step 3 to await for a DIFS period to prepare for retransmission.

If any data retransmitted from another interception node is detected during this DIFS waiting time, the transmission control part 915 goes to step 5 to monitor the retransmission by the interception node. If receiving an ACK2 signal from the node or if receiving an ACK3 signal from the interception node, the transmission control part 915 clears the retransmission buffer and returns to step 1 to wait for data, since data retransmission is not required any more.

If receiving neither ACK2 nor ACK3 signal from any interception node even after a predetermined time is over or if receiving a NACK2 or NACK3 signal from an interception node, the transmission control part 915 regards it as notification of the failure of the subject retransmission by the interception node and returns to step 3 to await for a DIFS period to prepare for retransmission.

If a timeout occurs after awaiting for a DIFS period, the transmission control part 915 determines a back-off period to be set in the back-off counter, then goes to step 4 to await for the back-off period.

In this state, the transmission control part 915 monitors data retransmission to be made by an interception node in the neighborhood. If no data retransmission is detected during this back-off period, the transmission control part 915 goes to step 5 to repeat the processing therein.

If the back-off period is over without detecting any data retransmission by any interception node in the neighborhood, the transmission control part 915 executes data retransmission, then returns to step 2 to wait for an ACK signal with respect to the retransmitted data.

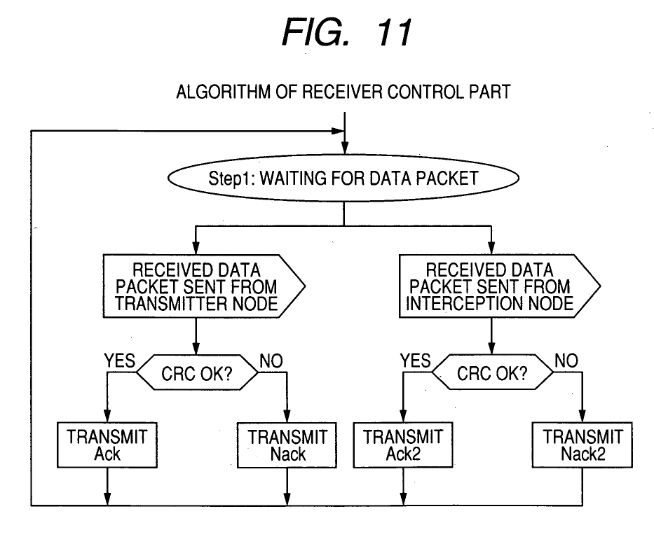

Next, there will be described an algorithm employed for the processings of the receiver control part 918 in the first to third embodiments of the present invention with reference to FIG. 11.

In the initial status, the receiver control part 918 is waiting for data to be received from the decoder 912 of the baseband signal processor 903 (step 1).

Upon receiving data, as shown in FIG. 14, the receiver control part 918 checks the sub-type field of the data frame control part for whether the data is transmitted from a transmitter node or retransmitted from an interception node.

Upon receiving data transmitted from a transmitter node, the receiver control part 918 checks the CRC or FCS, etc. for data frame error existence. If detecting no error, the receiver control part 918 transmits an ACK signal to the transmitter node. If detecting a frame error in the data, the receiver control part 918 transmits a NACK signal to the transmitter node. Depending on the mounted hardware items, even if detecting a frame error in the data, the receiver control part 918 is not required to do anything; the receiver control part 918 is not required to transmit the NACK signal, as well.

Even if the data is retransmitted from an interception node, the receiver control part 918 checks the CRC or FCS, etc. for frame error existence. If detecting no error, the receiver control part 918 transmits an ACK2 signal to the transmitter node. If detecting a frame error in the data, the receiver control part 918 transmits a NACK2 signal to the transmitter node. Depending on the mounted hardware items, even if detecting a frame error in the data, the receiver control part 918 is not required to do anything; the receiver control part 918 is not required to transmit the NACK signal, as well.

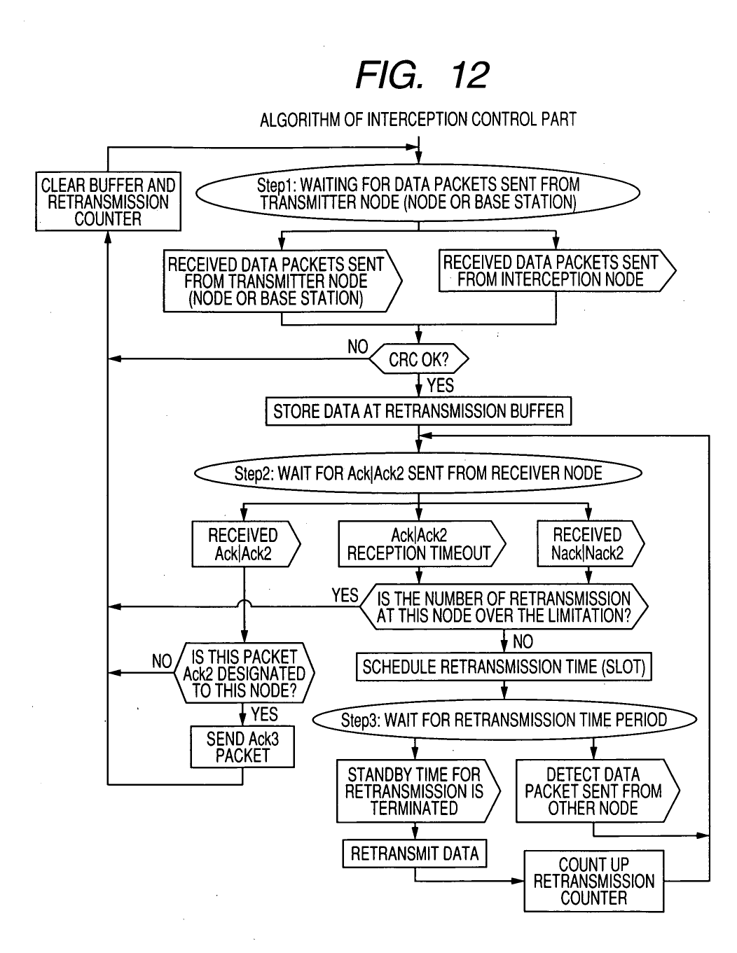

Next, there will be described an algorithm employed for the processings of the interception control part 917 in the first to third embodiments of the present invention with reference to FIG. 12.

At first, the interception control part 917 checks the data received from the decoder 912 of the baseband signal processor 903 to whether to wait for interception of data to be received from a node other than its own node (step 1). The control part 917 regards this status as its initial status.

The interception control part 917 intercepts data transmitted from a transmitter node or retransmitted from an interception node. The interception control part 917 checks the CRC, FCS, etc. set in each of those data for frame error occurrence.

If detecting a frame error in the received data, the interception control part 917 returns to step 1 to wait for intercepted data, since the interception control part 917 cannot involve in any retransmission of intercepted data. If detecting no frame error in the received data, the interception control part 917 stores the data in the retransmission buffer 916, then waits for an ACK or ACK2 signal to be received from the receiver node (step 2).

If intercepted data is encoded and a frame error can be detected even in such encoded data, the interception control part 917 stores the encoded data in the retransmission buffer as is. If the subject intercepted data is required to be decoded and otherwise it is impossible to check frame errors nor read the header information of the data, it is premised that the subject interception node is also enabled to obtain a decoding key with use of an authentic protocol and decode the data with use of the decoding key, then the interception control part 917 makes frame error checks and header analysis. Furthermore, at the time of retransmission, the data is required to be encoded again.

If receiving an ACK or ACK2 signal in step 2, it means that data is received by the receiver node correctly. Thus, the interception control part 917 is not required to retransmit intercepted data stored in the buffer.

If receiving an ACK or ACK2 signal addressed to a node other than its own one, the interception control part 917 clears both the buffer and the retransmission count, then returns to step 1 (initial status).

If receiving an ACK2 signal with respect to the data retransmitted from its own node, the interception control part 917 transmits an ACK3 signal to the transmitter node, then clears both the buffer and the retransmission count, then returns to step 1 (initial status).

If a timeout occurs before receiving an ACK or ACK2 signal or if receiving a NACK or NACK2 signal clearly in step 2, the interception control part 917 checks the retransmission count at its own node. And if the count reaches the upper limit value, the interception control part 917 clears the retransmission count without involving in the retransmission, then returns to step 1 (initial status).

If the retransmission count does not reach the upper limit yet at its own node, the interception control part 917 determines a retransmission slot (retransmission time), then goes to step 3 to await until the retransmission time is reached. If detecting any data retransmitted from another interception node or the transmitter node during this waiting time, the interception control part 917 returns to step 2 to wait for an ACK/ACK2 signal to be received from the receiver node.

If reaching the waiting time before detecting any data retransmitted from any of the interception nodes and the transmitter node in the neighborhood, the interception control part 917 retransmits the data stored in the buffer and counts up the retransmission count, then returns to step 2 to wait for an ACK/ACK2 signal to be received from the receiver node.

### Fourth Embodiment

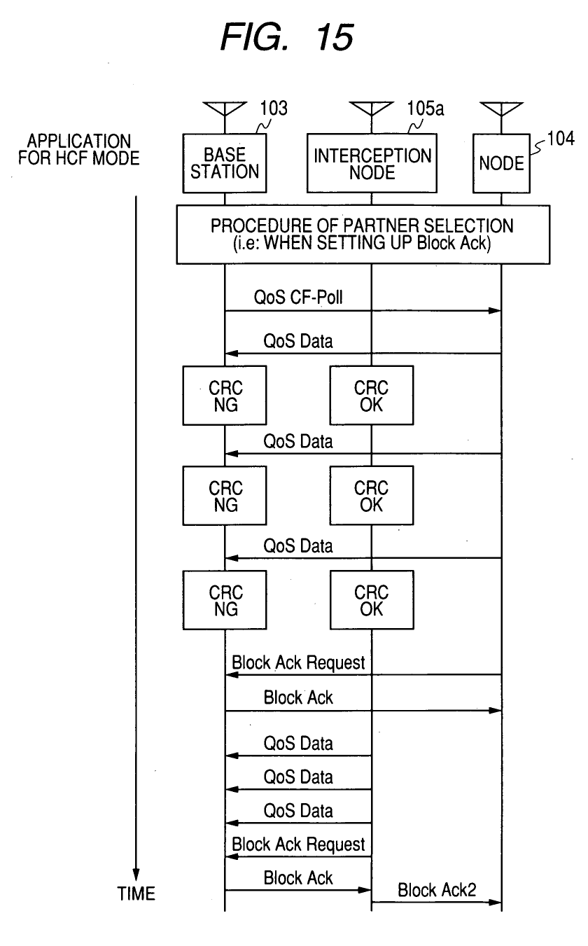

FIG. 15 shows a diagram for describing a retransmission control flow in a fourth embodiment of the present invention.

In case of the wireless LAN standards, a selective repetition method is employed to realize controlling of data retransmission. According to this method, when the base station 103 calls the node 104 with a polling signal referred to as the QoS CF-Poll, the node 104 transmits plural QoS data signals to the base station 103 collectively. And at the end of the transmission, the node 104 transmits a control signal referred to as a Block Ack Request to the base station 103.

The base station 103 then collects the result of each frame error check of the QoS Data signal. And upon receiving a Block Ack Request control signal, the base station 103 notifies the node 104 of a frame error with use of the control signal.

In case of the conventional wireless LAN standards, the node selects only frame error detected data and retransmits the data to the base station 103 again. In this fourth embodiment of the present invention, however, the interception node 105a receives a Block Ack signal and retransmits the frame error detected data to the base station 103. And because the interception node 105a retransmits plural QoS Data signals at that time, the interception node 105a notifies the base station 103 of the Block Ack Request to obtain a result of the Block Ack processing.

Furthermore, the interception node 105a adds the addresses of both the transmitter node and the interception node to the result of the Block Ack processing to form a Block Ack2 signal, then notifies the node 104 of the success of the retransmission with the Block Ack2 signal. It is also possible here to register the interception node 105a as a partner at the time of setting up the Block Ack.

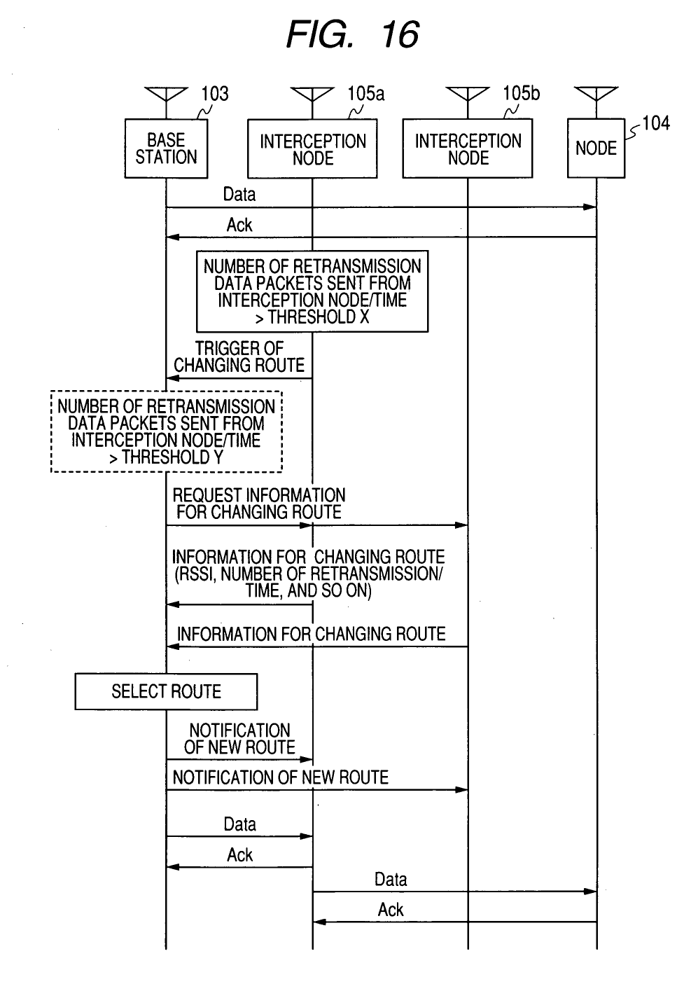

FIG. 16 shows a diagram for describing a route changing control flow that uses an interception node of the present invention.

While the base station 103 transmits data to the node 104, the interception node 105a counts the number of times having been involved in the data retransmission per unit time in the retransmission control flow described above as an interception node. If the value of the counting at the interception node 105a exceeds a preset threshold value (X times), the interception node 105a transmits a route change trigger to the base station 103 as a control signal.

The base station itself may also manage the count of retransmission by each subject interception node to determine a route change trigger, which is pulled when the count of retransmission by the subject interception node per unit time exceeds a preset threshold value (Y times).

The base station 103 then transmits a route change request control signal to the interception node 105a/105b. The interception node 105a/105b notifies the base station 103 of the receiving power RSSI measured value, transmission loss, retransmission count per unit time, etc. used for partner determination, etc. with use of the control signal of route change determination information notification.

The base station 103 determines a route according to the information obtained with the control signal of route change determination information notification. If the receiving power RSSI and transmission loss are used to determine a route, the above method for determining a partner is used to select an interception node as a relay node.

Otherwise, the relay node is selected from among interception nodes having been used most for retransmission per unit time.

The base station 103 then notifies the interception node 105a/105b of this relay node selection result with use of a route change notification control signal.

If a candidate route is determined beforehand in such a process as a partner registration, the base station 103 may determine the relay node route as its partner and output a route change notification control signal to the interception node 105a/105b; at this time, the base station 103 is not required to issue any route change request control signal.

And when the interception node 105a specified as a relay node with this route change notification control signal rewrites the route table, data output from the base station 103 is relayed to the base station 104.

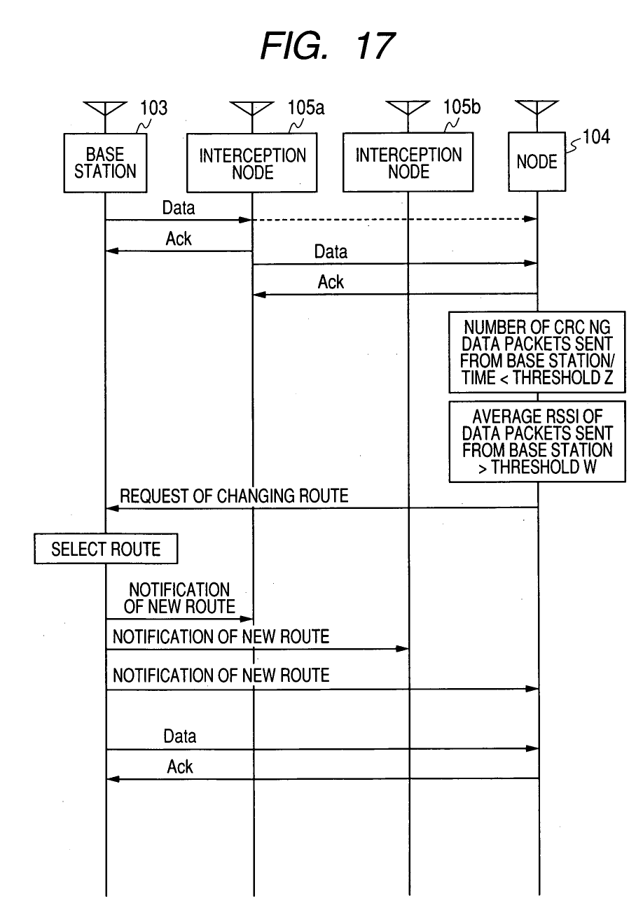

FIG. 17 shows a diagram for describing a control flow for changing a route that uses an interception node to a route that does not use any interception node in this fourth embodiment of the present invention.

The node 104, if possible to receive data signals from the base station 103 in addition to relayed data signals from the interception node 105a, decodes data received from the base station 103 and checks the CRC and FCS for frame data error existence. If the number of frame errors detected in the data received from the base station 103 per unit time is under a predetermined threshold value Z, the node 104 may be returned to the previous route.

If the average value of the measured RSSI values with respect to the data received from the base station 103 is over a threshold value W, it means that the received signal strength is enough. The node 104 may thus be returned to the previous route.

If any one of such conditions is satisfied or all those conditions are satisfied, the node 104 notifies the base station 103 of the route change request control signal. Upon receiving the request, the base station 103 notifies the interception node 105a/105b and the node 104 of the request with use of a route change notification control signal, then returns to the data communication route connected directly to the node 104.

The base station 103, if receiving a route change request control signal from the node 104, may issue a route change request to the interception node 105a/105b to collect information such as RSSI, etc. used to determine whether to change the route again, then determine whether to change the route to another as shown in FIG. 16.

As described above, according to the present invention, if the wireless communication between a transmitter node and a receiver node is unstable, it is possible to suppress an increase of the transmission delay time that might occur due to such retransmission controls, thereby the transmission error occurrence can be reduced. This is why the present invention can apply to retransmission controlling of any wireless communication systems.

What is claimed is:

1. A communication system, comprising a transmitter node, a receiver node, and an interception node,
wherein said transmitter node transmits a wireless signal including data and said receiver node receives said wireless signal from said transmitter node, then checks said data included in said wireless signal for error existence;
wherein said receiver node returns an ACK (Acknowledgement) signal if no error is detected in said data and does not return said ACK (Acknowledgement) signal if an error is detected in said data;
wherein said interception node intercepts data transmitted from said transmitter node and stores said intercepted data in storage unit; and
wherein said interception node retransmits said stored data to said receiver node if not detecting said ACK (Acknowledgement) signal transmitted from said receiver node and does not retransmit said stored data to said receiver node if detecting said ACK (Acknowledgement) signal transmitted from said receiver node.

2. The communication system according to claim 1,
wherein said receiver node transmits a NACK (Not Acknowledgement) signal to said transmitter node if detecting an error in said data included in said wireless signal received from said transmitter node.

3. The communication system according to claim 1,
wherein said receiver node checks said data retransmitted from said interception node for error existence; and
wherein said receiver node transmits a second ACK (Acknowledgement) signal to said interception node if not detecting any error in said data and does not transmit said second ACK (Acknowledgement) signal to said interception node if detecting an error in said data.

4. The communication system according to claim 3,
wherein said interception node retransmits said stored data to said receiver node if not detecting said second ACK (Acknowledgement) signal and does not transmit said stored data if detecting said second ACK (Acknowledgement) signal transmitted from said receiver node.

5. The communication system according to claim 1,
wherein said interception node intercepts data transmitted from said transmitter node as a wireless signal.

6. The communication system according to claim 1,
wherein said interception node intercepts data transmitted from said transmitter node as a wired signal.

7. The communication system according to claim 1,
wherein said interception node deletes said stored data from said storage unit if detecting an ACK (Acknowledgement) signal transmitted from said receiver node.

8. The communication system according to claim 1,
wherein said interception node retransmits said stored data to said receiver node by radio.

9. The communication system according to claim 1,
wherein said interception node retransmits said stored data to said receiver node by wiring.

10. The communication system according to claim 1,
wherein said system determines one interception node beforehand as a partner if there are a plurality of interception nodes; and
wherein said interception node selected as a partner retransmits data on behalf of said transmitter node.

11. A transmitter node for transmitting/receiving data to/from a receiver node,
wherein said transmitter node includes:
a unit that forms a data frame by adding a code to each received data, said code being used for checking said received data for error existence;
a unit that stores said data frame to prepare for retransmission;
a unit that modulates said data frame to a wireless data frame, then transmits said modulated wireless data frame;
a unit that determines the existence of an ACK (Acknowledgement) signal received from said receiver node;
a unit that determines the existence of any data retransmitted from an interception node if not receiving any ACK signal from said receiver node; and
a unit that controls a timing of transmission including retransmission of said data according to a result of said retransmission determination.

12. A receiver node for transmitting/receiving data to/from a transmitter node,
wherein said receiver node includes:
a unit that receives a wireless signal, demodulates said wireless signal to data, then decodes said demodulated data, thereby forming a data frame;
a unit that checks said received data frame for error existence; and
a unit that transmits an ACK (Acknowledgement) signal if not detecting any data error in said received data frame.

13. The receiver node according to claim 12,
wherein said receiver node does not transmit said ACK (Acknowledgement) signal if detecting an data error in said received data frame.

14. The receiver node according to claim 12,
wherein said receiver node transmits a NACK (Not Acknowledgement) signal if detecting an data error in said received data frame.

15. An interception node, comprising:
a unit that intercepts a wireless signal in a wireless communication between a transmitter node and a receiver node, then demodulates said received wireless signal, then decodes said demodulated data to form a data frame;
a unit that checks said data frame for error existence;
a unit that stores said data frame if not detecting any error in said data frame;
a unit that checks a retransmission request received from said receiver node;
a unit that controls a retransmission timing for retransmitting said stored data to said receiver node; and
a unit that modulates said retransmitted data frame to a wireless data frame, then transmits said modulated data frame by radio.
